(19) United States
(12) Patent Application Publication
(10) Pub. No.: US 2025/0139180 A1
(43) Pub. Date: May 1, 2025

(54) METHOD, DEVICE, AND STORAGE MEDIUM FOR CONTENT RECOMMENDATION

(71) Applicants: Beijing Youzhuju Network Technology Co., Ltd., Beijing (CN); Lemon Inc., Grand Cayman (KY)

(72) Inventors: Jun CHEN, Beijing (CN); Zhe WANG, Los Angeles, CA (US)

(21) Appl. No.: 18/932,348

(22) Filed: Oct. 30, 2024

(30) Foreign Application Priority Data
Oct. 30, 2023 (CN) 202311423731.2

(51) Int. Cl. G06F 16/9535; G06F 9/50; G06F 16/9538

(52) U.S. Cl. CPC G06F 16/9535; G06F 9/5005; G06F 16/9538

(57) ABSTRACT

In embodiments of the present disclosure, a solution for content recommendation is provided. The method includes determining a first estimated value metric obtained by delivering a first recommended content item; determining a first resource efficiency value of the first recommended content item based on a historical resource allocation amount and a historical value metric associated with the first recommended content item; determining a first resource allocation amount to be allocated to the first recommended content item based on the first resource efficiency value and a total resource allocation amount for the recommended content set; determining a first target estimated value metric for the first recommended content item based on the first estimated value metric and the first resource allocation amount; and determining a ranking result of the first recommended content item in the recommended content set based on the first target estimated value metric.

### CROSS-REFERENCE

This application claims priority to Chinese Patent Application No. 202311423731.2 filed on Oct. 30, 2023, and entitled “METHOD, APPARATUS, DEVICE, AND STORAGE MEDIUM FOR CONTENT RECOMMENDATION”.

### FIELD

Example embodiments of the present disclosure generally relate to the field of computer technologies, and in particular, to a method, apparatus, device, and computer-readable storage medium for content recommendation.

### BACKGROUND

The Internet offers access to a wide variety of resources. For example, various applications, commodities, audio and video content, and the like may be accessed through the Internet. In addition, the accessible content also includes specific recommended content items related to various objects/resources, such as advertisements. A content recommendation system may provide delivery of the recommended content item to the content provider, for example, deliver the recommended content item in a specific delivery opportunity to obtain a corresponding content click, conversion, and the like. The delivery of the recommended content items is typically based on competition. In the recommendation system, for a new recommended content item, its recommendation policy needs to be specially designed.

Taking an advertisement as an example, the advertiser often has a new delivery requirement in the promotion process, and the typical operation is to obtain a target delivery effect by creating a delivery plan. From the client's perspective, the new plan often encounters a cold start problem, which is specifically expressed as phenomena such as poor starting effect, unstable cost and the like, influencing the delivery experience of the advertiser, and reducing the willingness of the customer to invest in the budget and so on. From the perspective of the content recommendation system, a new advertisement is completely unknown to each module in the delivery link, for example, the estimation module learns insufficiently when the sample amount is insufficient, and the chain reaction of inaccurate estimation can easily lead to insufficient bidding on the platform, which affects the effect and revenue of content delivery.

### SUMMARY

In a first aspect of the present disclosure, a method for content recommendation is provided. The method includes: determining, for a first recommended content item in a recommended content set, a first estimated value metric obtained by delivering the first recommended content item; determining a first resource efficiency value of the first recommended content item based on a historical resource allocation amount and a historical value metric associated with the first recommended content item; determining a first resource allocation amount to be allocated to the first recommended content item based on the first resource efficiency value of the first recommended content item and a total resource allocation amount for the recommended content set; determining a first target estimated value metric for the first recommended content item based on the first estimated value metric and the first resource allocation amount; and determining a ranking result of the first recommended content item in the recommended content set based on the first target estimated value metric, the first recommended content item being delivered based on the ranking result.

In a second aspect of the present disclosure, an apparatus for content recommendation is provided. The apparatus includes: a value measuring module configured to determine, for a first recommended content item in a recommended content set, a first estimated value metric obtained by delivering the first recommended content item; an efficiency determining module configured to determine a first resource efficiency value of the first recommended content item based on a historical resource allocation amount and a historical value metric associated with the first recommended content item; a resource allocation amount determining module configured to determine a first resource allocation amount to be allocated to the first recommended content item based on the first resource efficiency value of the first recommended content item and a total resource allocation amount for the recommended content set; a target value measuring module configured to determine a first target estimated value metric for the first recommended content item based on the first estimated value metric and the first resource allocation amount; and a ranking determining module configured to determine a ranking result of the first recommended content item in the recommended content set based on the first target estimated value metric, the first recommended content item being delivered based on the ranking result.

In a third aspect of the present disclosure, an electronic device is provided. The apparatus includes at least one processing unit; and at least one memory coupled to the at least one processing unit and storing instructions for execution by the at least one processing unit. The instructions, when executed by the at least one processing unit, cause the apparatus to implement the method of the first aspect.

In a fourth aspect of the present disclosure, a computer-readable storage medium is provided. The medium stores a computer program thereon, and when the computer program is executed by the processor, the method in the first aspect is implemented.

It should be appreciated that the content described in this section is not intended to limit critical features or essential features of the embodiments of the disclosure, nor is it intended to limit the scope of the disclosure. Other features of the present disclosure will become readily appreciated from the following description.

### BRIEF DESCRIPTION OF DRA WINGS

The above and other features, advantages and aspects of embodiments of the present disclosure will become more apparent with reference to the following detailed description taken in conjunction with the accompanying drawings. In the drawings, the same or similar reference numerals denote the same or similar elements, wherein:

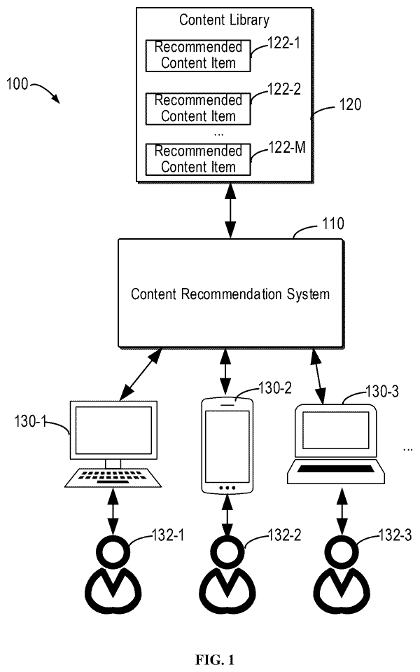

FIG. 1 illustrates a schematic diagram of an example environment in which embodiments of the present disclosure can be implemented;

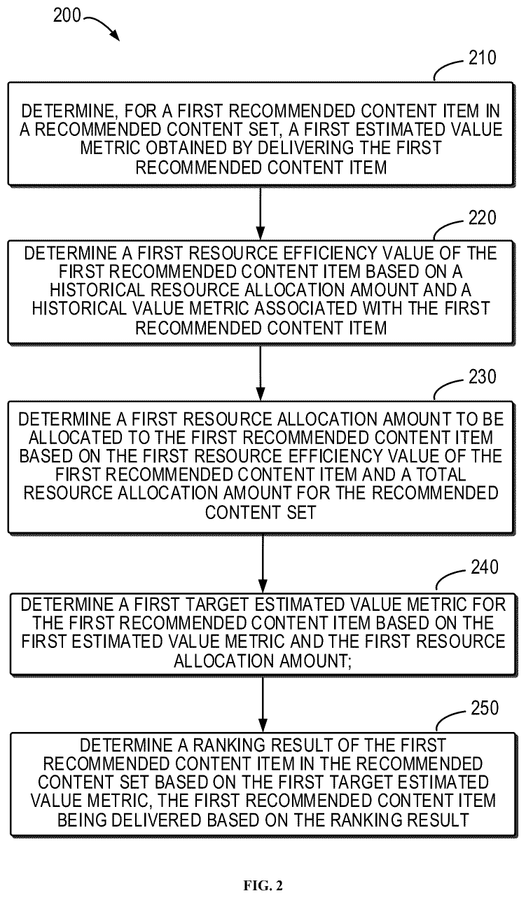

FIG. 2 illustrates a flowchart of a process for content recommendation according to some embodiments of the present disclosure;

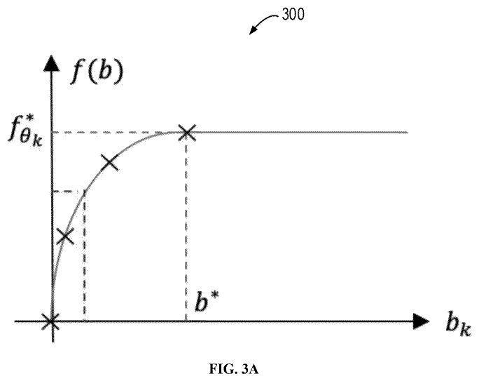

FIG. 3A illustrates an example of a value function according to some embodiments of the present disclosure;

FIG. 3B illustrates an example of a value function and an approximation function thereof according to some embodiments of the present disclosure;

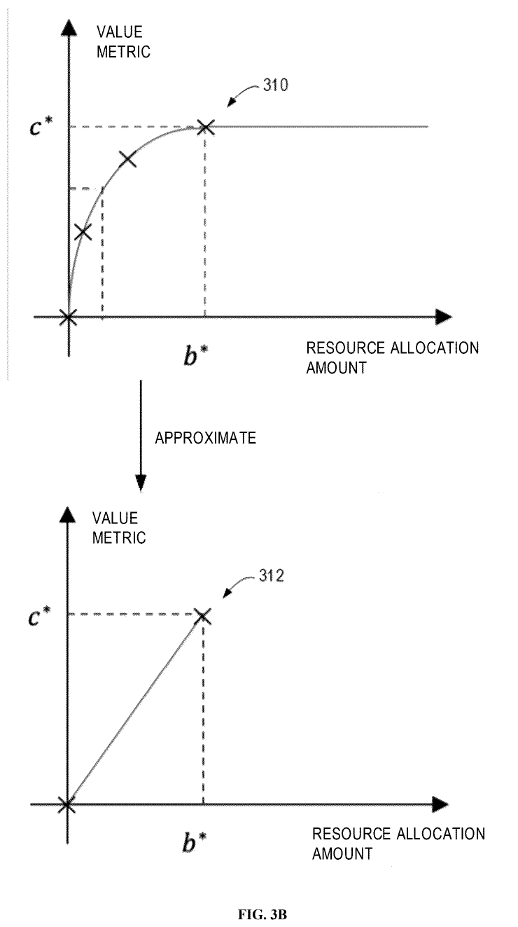

FIG. 4 illustrates an example of an architecture for content recommendation according to some embodiments of the present disclosure;

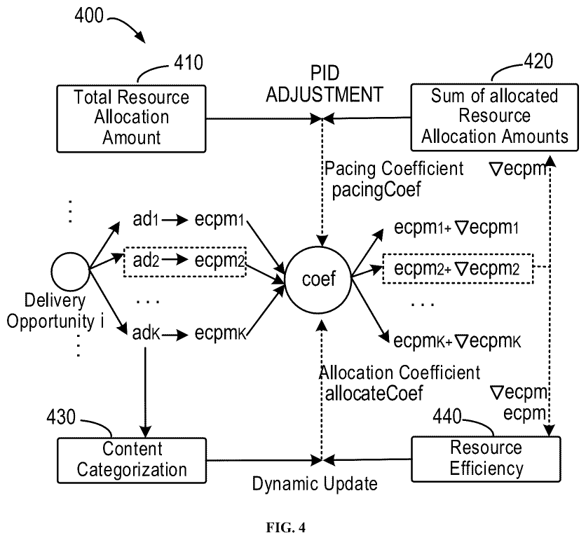

FIG. 5 illustrates a block diagram of an apparatus for content recommendation according to some embodiments of the present disclosure; and

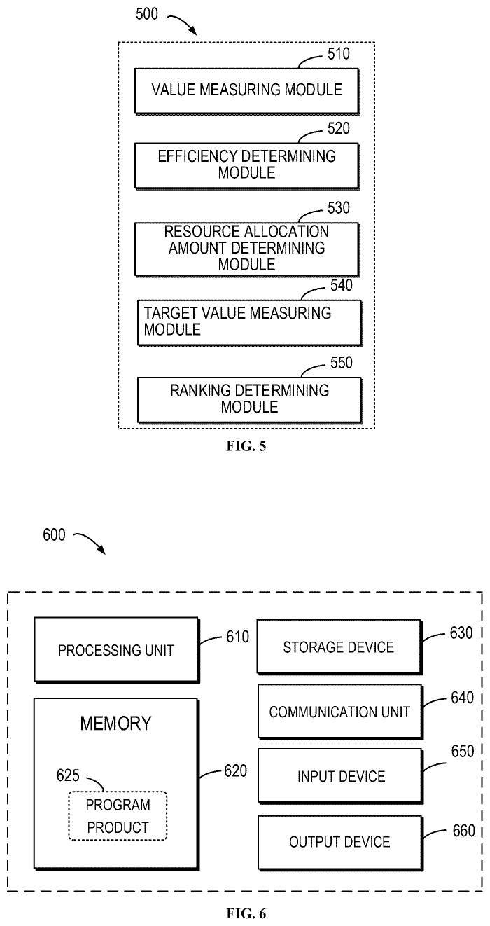

FIG. 6 illustrates a block diagram of an electronic device in which one or more embodiments of the present disclosure may be implemented.

### DETAILED DESCRIPTION

Embodiments of the present disclosure will be described in more detail below with reference to the accompanying drawings. While some embodiments of the present disclosure are shown in the figures, it shall be understood that the present disclosure can be implemented in various forms and should not be construed as limited to the embodiments set forth herein. On the contrary, these embodiments are provided for a more thorough and complete understanding of the present disclosure. It shall be understood that the drawings and embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “one embodiment” or “the embodiment” should be understood as “at least one embodiment”. The term “some embodiments” should be understood as “at least some embodiments”. Other explicit and implicit definitions may also be included below.

It will be appreciated that the data involved in the technical solution (including but not limited to the data itself, the obtaining or use of the data) should comply with the requirements of the corresponding legal regulations and related provisions.

It will be appreciated that, before using the technical solutions disclosed in the various embodiments of the present disclosure, the user shall be informed of the type, application scope, and application scenario of the personal information involved in this disclosure in an appropriate manner and the user's authorization shall be obtained, in accordance with relevant laws and regulations.

For example, in response to receiving an active request from a user, prompt information is sent to the user to explicitly prompt the user that an operation requested by the user will require obtaining and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It can be understood that the above notification and user authorization process are only illustrative which do not limit the implementation of this disclosure. Other methods that meet relevant laws and regulations can also be applied to the implementation of this disclosure.

FIG. 1 illustrates a schematic diagram of an example environment 100 in which embodiments of the present disclosure can be implemented. The content recommendation system 110 is configured to present the recommended content item in a delivery opportunity. The recommended content items to be recommended may include, for example, one or more recommended content items 122-1, 122-2, . . . 122-M (collectively or individually referred to as the recommended content item 122 for ease of discussion) in content database 120.

Recommended content items may be presented to individual users. As shown in FIG. 1, one or more terminal devices 130-1, 130-2, 130-3, etc. (collectively or individually referred to as terminal devices 130 for ease of discussion) are associated with the content recommendation system 110 and may access various content provided on the content recommendation system 110, e.g., based on respective audiences 132-1, 132-2, 132-3, etc. (collectively or individually referred to as audiences 132 for ease of discussion). As an example, the content recommendation system 110 may be an application, a website, a web page, and other accessible platforms. The terminal device 130 may be installed with an application for accessing the content recommendation system 110, or may access the content recommendation system 110 in a suitable manner. The content recommendation system 110 may be configured to deliver one or more specific recommended content items in a corresponding delivery opportunity or content showing opportunity (e.g., provided or delivered in the terminal device 130) based on the respective policies.

Herein, a recommended content item refers to content that is presented in order to recommend corresponding resources. Examples of recommended content items may include advertisements. Herein, a delivery opportunity or content presentation opportunity may be divided in terms of user (or audience) granularity, each of the audiences may correspond to one delivery opportunity. In addition to a user, the delivery opportunity may also be divided according to a granularity of one delivery time, a specific display location of the page, and the like.

In some embodiments, the content recommendation system 110 may recommend a corresponding recommended content item on the content recommendation system 110 based on a request from the content provider. In a scenario of advertisement delivery, the content provider 150 is sometimes also referred to as an advertiser. In some embodiments, the content provider may also pay the content provider based on the presentation of the recommended content item and subsequent conversions, etc. In some embodiments, the content recommendation system 110 may determine the recommended content item 122 presented in the corresponding delivery opportunity based on the bidding result.

In the environment 100, the terminal device 110 may be any type of mobile terminal, fixed terminal, or portable terminal, including a mobile phone, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, gaming device, or any combination of the foregoing, including accessories and peripherals of these devices, or any combination thereof. In some embodiments, the terminal device 110 can also support any type of interface for a user (such as a “wearable” circuit, etc.). The content recommendation system 110 may be, for example, various types of computing systems/servers capable of providing computing power, including, but not limited to, mainframes, edge computing nodes, computing devices in a cloud environment, and the like.

It shall be understood that the structures and functions of the various elements in the environment 100 are described for exemplary purposes only, which do not imply any limitation to the scope of the present disclosure.

As previously described, cold start is a necessary phase in a recommended content item delivery plan. The content cold start refers to that: new content is unknown to the recommendation system without accumulation of history information, and basic data needs to be collected by accumulating a certain amount of exposure and interaction, and the process of accumulating the basic data is cold start. In this application, the content cold start may also include an advertisement cold start. In an advertisement scenario, a cold start refers to a learning phase in which an advertisement is delivered from the beginning to a stable delivery, and advertisement delivery data is continuously accumulated in the cold start phase, so that the content recommendation systems can obtain enough data samples to perform stable content recommendation. Recommended content items or advertisements in a cold start phase are sometimes also referred to as cold recommended content items or cold advertisements.

How to make the conversion samples of the newly created recommended content items quickly accumulated in a short period get though the cold start phase is a guarantee for long-term stable operation of the content delivery platform and budget introduction. The problem can be optimized from several aspects of the content delivery link, such as a recall phase, an estimation phase, a precise ranking phase, and the like. In the content recommendation systems, the recall phase refers to recalling a certain number of recommended content items from the global recommended content item candidates. The estimation phase refers to estimating a cost, a click-through rate, a conversion rate, and the like of the recommended content item, which may usually be implemented by training an estimation model. The precise ranking phase refers to ranking the recalled recommended content items, and delivering the top-ranked recommended content items or highest-ranked recommended content item in a specific delivery opportunity.

Cold start problems are common research topics in the field of content recommendation. There has been a lot of researches and optimizations on the problem to provide better experience for content providers. Some optimization strategies include cold path recall, generalization estimation, and the like. Still other optimization strategies focus on the supporting strategy for the precise ranking phase for the recommended content items. In competition-based content delivery, for a specific delivery opportunity, the recommended content items are usually ranked according to the estimated revenue of the recommended content item, so as to select the recommended content item with the highest ranking as the competitor of the delivery opportunity. Estimated revenue refers to revenue that can be obtained by assuming that a recommended content item is presented in the specific delivery opportunity.

In an advertisement scenario, epcm (Expected Cost Per Miles, an expected cost shown per thousand times) is usually used as a value metric indicator of the estimated revenue. For a delivery opportunity, ecpm of a recommended content item may be calculated as follows: ecpmᵢ=bidᵢ*pctrᵢ*pcvrᵢ, where bidᵢ refers to the bid of the recommended content item to the delivery opportunity, pctrᵢ refers to an expected click-through rate of the recommended content item when being presented to the delivery opportunity, pcvrᵢ refers to an expected conversation rate of the recommended content item when being presented to the delivery opportunity. If in the delivery opportunity, there are N advertisements competing in the precise ranking phase, and the estimated revenue of the j-th advertisement on the delivery opportunity i is ecpmᵢⱼ, the determining of the advertisement that can compete to get the delivery opportunity can be expressed as:

$${j}^{*} = arg {max}_{j = 1}^{j = N} ( {ecpm}_{ij} ) \qquad ( 1 )$$

For the advertisement in the cold start phase, a supporting strategy may be applied to the content recommendation system to increase the exposure opportunity for the advertisement. The supporting strategy for cold start generally refers to the system increasing the ranking of the “cold” advertisement by an “additional item” ∇ecpm. This can act on the starting speed optimization of the cold advertisements and improve the cold start passing rate. In this context, the above delivery opportunity may be expressed as:

$${j}^{*} = arg {max}_{j = 1}^{j = N} ( {ecpm}_{ij} + ∇ {ecpm}_{ij} ) \qquad ( 2 )$$

Here, the “additional item” ∇ecpm may also be referred to as the resource allocation amount of the corresponding recommended content item, and the resource allocation amount is additionally added to the corresponding recommended content item, and thus may be referred to as “supporting” the recommended content item.

From the perspective of the content recommendation system, ∇ecpm is revenue loss that needs to be afforded by the content recommendation system, that is, the advertisement that competes for obtaining the delivery opportunity participates ranking by using ecpmᵢⱼ+∇ecpmᵢⱼ, but the revenue obtained finally by the content recommendation platform from the content provider is still ecpmᵢⱼ, that is, the cost to be paid by the content provider is ecpmᵢⱼ. Obviously, the cold start supporting can improve the cold advertisement delivery experience of the advertiser, but the content recommendation platform also needs to afford a certain revenue loss. In order to avoid excessive revenue loss caused by supporting, the total resource allocation budget of the supporting strategy is usually given on the basis of comprehensively considering cold start revenue and revenue loss. Therefore, the cold start supporting strategy can be expressed simply as:

$${j}^{*} = arg {max}_{j = 1}^{j = N} ( {ecpm}_{ij} + ∇ {ecpm}_{ij} ) \qquad ( 3 )$$

$$s . t . {\sum }_{i} ∇ {ecpm}_{ij *} \leq B$$

For content recommendation supporting under the constraint of total resource allocation B, the solution of the current scenario may be summarized as follows.

One solution is a fixed supporting solution. For each delivery opportunity, resource allocation amount for a cold advertisement is determined by a fixed coefficient (denoted as fixed_coef), that is, ∇ecpmᵢⱼ=fixed_coef*ecpmᵢⱼ, until the sum of the revenue losses (i.e., the sum of resource allocation amounts) of the content recommendation system over a time period reaches a predetermined budget B for that time period. The solution is simple and easy to implement, but there is a defect that the fixed coefficient is difficult to be determined, and the spending of total resource allocation amount of the budget is not smooth.

Another solution is a dynamic supporting solution. For each delivery opportunity, a supporting gain of a cold advertisement is determined by a dynamic coefficient, that is, ∇ecpmᵢⱼ=pacing_coef*ecpmᵢⱼ. Herein, pacing_coef is a dynamic coefficient calculated by observing a spending progress of the total resources allocation in real-time and using a pacing algorithm. For example, pacing_coef=PID (B, Σ∇ecpmᵢ) may be determined based on a classic PID control algorithm. Compared with the above solution, this solution can smoothly spend the total resource allocation amount. However, since all the advertisements share the same coefficient pacing_coef at any moment, the value difference of different advertisements in the cold start phase is not considered, resulting in a lower overall supporting resource efficiency of the cold start.

Although an advertisement scenario is used as an example for description, similar problems still exist in other recommendation scenarios and other types of recommended content items.

For a transition problem of the recommended content item in the cold start phase, it is necessary to consider how to allocate the total resource allocation amount for supporting into respective recommended content item in the cold start phase, so that the overall value of the cold start of the content recommendation systems is maximized. In addition, it is also necessary to consider how each recommended content item should spend the allocated budget in order to quickly get through the cold start phase to improve the customer's delivery experience.

In the embodiment of the present disclosure, a cold start supporting solution based on resource efficiency is provided, which may dynamically perceive resource efficiency in real time to perform adaptive resource allocation, so that bidding environment changes such as changes in content provider operations, delivery opportunities and the like can be better responded to, and the cold start delivery effect is remarkably improved. In some embodiments, the solution may be implemented in a precise ranking phase of the content recommendation process to optimize a ranking result of respective pieces of recommended content, thereby affecting whether the recommended content can be presented to a specific delivery opportunity.

Some example embodiments of the present disclosure will be described below with continued reference to the accompanying drawings.

FIG. 2 illustrates a flowchart of a content recommendation process 200 according to some embodiments of the present disclosure. The process 200 may be implemented at the content recommendation system 110 of FIG. 1.

At block 210, the content recommendation system 110 determines, for a first recommended content item in a recommended content set, a first estimated value metric obtained by delivering the first recommended content item.

In some embodiments, the recommended content set includes a plurality of recommended content items, and these recommended content items refer to recommended content items to be delivered in a particular delivery opportunity or content showing opportunity. For example, a delivery opportunity or content showing opportunity in the content recommendation system 110 may be divided at a granularity of users, or at a granularity of a particular time period or a particular showing location in a page, or the like. In some embodiments, the recommended content set includes at least recommended content items in the content recommendation system 110 determined as being in a cold start phase. Herein, the recommended content set includes at least “cold” recommended content items to share the total resource allocation amount of the content recommendation system 110 over a time period.

Embodiments of the present disclosure relate to selecting a recommended content item from a recommended content set for delivery. For the recommended content item in the cold start phase, the probability that the recommended content item is delivered is improved by the cold start supporting provided with a certain amount of resources. Here, it is assumed that the “first recommended content item” discussed herein is a recommended content item in a cold start phase, and the recommended content set may further include one or more recommended content items in the cold start phase. It may be understood that although a single recommended content item is described below, the content recommendation system 110 may perform cold start resource allocation and delivery determination in a similar manner for each recommended content item in the cold start phase.

In some embodiments, for the first recommended content item, its estimated value metric may be measured, for example, by the expected cost ecpm shown each thousand times. From a perspective of content provider (e.g., advertiser), ecpm refers to an expected cost to be paid by a content provider (e.g., advertiser) for delivery of recommended content items. From the perspective of the content recommendation system, ecpm refers to the revenue that is expected to be obtained from the content provider after delivering the recommended content item.

At block 220, the content recommendation system 110 determines a first resource efficiency value of the first recommended content item based on a historical resource allocation amount and a historical value metric associated with the first recommended content item.

As mentioned above, the supporting problem of the recommended content item in the cold start phase can be split into two sub-problems. The first sub-problem is a resource allocation problem for supporting, that is, how to allocate the total resource allocation amount into each recommended content item in the cold start phase, so that the overall value of the cold start of the content recommendation systems is maximized. The second sub-problem is a problem of spending resource allocation amount of a recommended content item, that is, how each recommended content item should spend the allocated resource budget in order to quickly get through the cold start phase, so as to improve the delivery experience of the client. Here, the resource allocation refers to any resource that can help the recommend content items increase their ranking positions. For the overall recommended content set, each recommended content item therein shares a budget for one resource allocation, that is, the total resource allocation amount.

The budget allocation problem can be defined as: assuming that the total resource allocation amount given by the content recommendation systems is B, it is expected to optimize the cold start effect of the content provider, so that the content delivery intention of the content provider is more continuous, then how to allocate the total resource allocation amount B to the recommended content item granularity is considered, so that the cold start value is maximized. This problem can be expressed as a value function as follows:

$$max {\sum }_{k} {f}_{{θ}_{k}} ( {b}_{k} ) \qquad ( 4 )$$

$$s . t . {\sum }_{k} {b}_{k} \leq B$$

where bₖ represents the total resource allocation amount that is allocated to the k-th recommended content item among all K recommended content items in the recommended content set. The above Equation (4) represents that in a case that the sum of the resource allocation amounts of all K recommended content items does not exceed the total resource allocation amount B, it is expected that the sum of the value functions ƒ_{θ}_{ₖ} corresponding to the K recommended content items is maximized. FIG. 3A illustrates an example of the value function ƒ_{θ}_{ₖ}, which can be considered as a two-parameter function with diminishing marginal revenues. The problem of Equation (4) above requires dynamic programming solution.

On the other hand, the resource allocation budget division problem for each recommended content item may be defined as: given the total resource allocation amount bₖ of the k-th recommended content item itself, it is expected to optimize the conversion situation after the recommended content item is delivered, so that the recommended content item may get through the cold start period quickly, and the delivery experience of the client is improved. In advertisement bidding, this problem can be converted into incremental revenue ∇ecpmᵢ of the k-th recommended content item for each delivery opportunity (which can be considered as the resource allocation amount divided from the total resource allocation amount to the delivery opportunity), to maximize the number of conversions for the recommended content item. This problem can be expressed as follows:

$$max {\sum }_{i} {x}_{i} * {pctr}_{i} * {pcvr}_{i} \qquad ( 5 )$$

$$s . t . {\sum }_{i} {x}_{i} * ∇ {ecpm}_{i} \leq {b}_{k}$$

In the above Equation (5), the value of xᵢ being 1 or 0 indicates whether the k-th recommended content item is delivered in the delivery opportunity or not in the delivery opportunity. That is, only when being delivered in the delivery opportunity, the k-th recommended content item consumes a portion of the resource allocation amount. The calculation of ∇ecpmᵢ may be expressed as ∇ecpmᵢ=α^{*}*pctrᵢ*pcvrᵢ, which may be approximated to the Cost-Per-Conversion (CPA) bid, and may be used to directly optimize the conversion of the recommended content items. In an actual recommendation scenario, the adjustment parameter a*may be used to adjust ∇ecpmᵢ. According to the above Equation (5), for the k-th recommended content item, it is expected to select an appropriate delivery opportunity for delivery without exceeding the total resource allocation amount bₖ allocated to the k-th recommended content item, so as to maximize its conversion number, that is, the predicted click-through rate (pctr) and the projected conversion rate (pcvr).

In resource allocation for recommended content items, resource efficiency indicators may also be considered. The resource efficiency indicator may be defined as Effciency=target/∇ecpm, and the target revenue target is generated directly by the resource allocation amount ∇ecpm. The higher the efficiency, the more revenue can be brought to the cold start of the recommended content item under the same resource allocation amount. Taking the calculation of the target revenue target as the value metric cost on a single delivery opportunity as an example:

TABLE 1

| ecpm | ecpm + ∇ecpm |
|---|---|
| 3 | 4(∇ecpm = 3) |
| 2 | 3 |
| 1 | 2 |

In the above table, it is assumed that for three recommended content items, the respective estimated value metrics ecpm are 3, 2, and 1 respectively, and if cold start supporting is not performed, the recommended content item with ecpm of 3 will be delivered to the current delivery opportunity. However, if a recommended content item with ecpm of 1 is supported (i.e., a certain resource amount is allocated), that is ∇ecpm=3, the total value metric of the recommended content item is 4, which will be higher than the remaining two recommended content items, so that the recommended content item can be delivered to the current delivery opportunity. From the perspective of the content recommendation system, the direct revenue generated by the resource allocation of the recommended content item with ecpm of 1 is 1, which results in a revenue loss of ∇ecpm=3, and the resource efficiency k=⅓.

The value function can describe a resource efficiency of a recommended content item, a functional relationship between the “resource allocation amount” delivered to the recommended content item and the “direct revenue” is defined. Generally, with the investment on the resource allocation, the target growth revenue tends to be decreasing, which is usually defined as a hyperparameter convex function as shown in FIG. 3A. However, in practical applications, the resource allocation amount is not infinite, but is often limited. Thus, in some embodiments, the value function is approximated as a phenomenal function of the resource allocation amount and the value metric based on the requirements of the actual application and the consideration of computational efficiency. That is, in a case where the resource allocation amount is limited, the resource allocation amount and the value metric may be approximated as being linearly related.

FIG. 3B illustrates an example of a value function 310 in accordance with some embodiments of the present disclosure, in which the value metric c* increases as the resource allocation amount b* increases. When the resource allocation amount supported is infinite, the value metric will be maximized. However, considering that the resource allocation amount is limited, the resource allocation amount and the value metric may be approximated as being linearly related, as shown by the approximation function 312 of the value function of FIG. 3B. As such, target=k*∇ecpm, where the target revenue target may be denoted as a value metric ecpm, k represents a resource efficiency value.

Considering the linear relationship between the resource allocation amount and the value metric, in practical applications, the historical resource allocation amount and the historical value metric of the first recommended content item may be collected, that is, (∇ecpm, target) constitute a point of the value function. The line type of the value function can be determined by (∇ecpm, target), and then the resource efficiency value k of the first recommended content item is determined. Herein, the historical resource allocation amount may include a resource allocation amount allocated to the first recommended content item when the first recommended content item is successfully delivered to a certain delivery opportunity, and the historical value metric may include a direct revenue obtained from the first recommended content item in this delivery, for example, the revenue may be calculated according to ecpm.

According to the above discussion, a preferred solution is to allocate a “total resource allocation amount” bₖ for each recommended content item based on the resource efficiency value by using the recommended content item as a granularity, and pace the support for the recommended content item based on the total resource allocation amount. However, if the number of recommended content items that need to be processed by the content recommendation system 110 is large, the overall workload and complexity of this solution are large, and the granularity of the single recommended content item may face the dilemma of data sparsity and untrusted value function. In some embodiments of the present disclosure, by dividing the recommended content items in the cold start phase into categories, the recommended content items of the same category may share the same value function, that is, the same resource efficiency value. In this way, the resource efficiency value of the same category can be used to approximate the theoretical optimal solution based on efficiency allocation budget and dynamic regulation.

Specifically, in some embodiments, the content recommendation system 110 divides the recommended content items in the recommended content set into a plurality of categories. The recommended content items of the same category may be approximately regarded as the same recommended content item for calculating the resource efficiency value, which may greatly reduce the complexity of solving and applying the strategy. The allocation solution for the recommended content items may have multiple optional manners, including rule-based categorization, model-based clustering, and the like. For example, the rule-based categorization may include dividing recommended content items with the same conversion definition into the same category. The same conversion definition may include considering activation, downloading, registration, or filling out of a form, etc., for the recommended content item as a conversion action.

For each category of the plurality of categories, the content recommendation system 110 may determine a resource efficiency value for the category based on historical resource allocation amounts allocated to the category of recommended content items and historical value metrics obtained for presentation of the category of recommended content items. Since multiple recommended content items may be included in the same category, more the historical resource allocation amounts and the historical value metrics may be obtained. As mentioned above, the historical resource allocation amounts and the historical value metrics satisfy a value function with a linear relationship. More historical sampling points will help fitting a more accurate resource efficiency value k in the linear function.

Assuming that the first recommended content item is divided into a first category of the plurality of categories, the resource efficiency value for the first category may be determined as the first resource efficiency value of the first recommended content item. For other recommended content items, the resource efficiency value thereof may be similarly determined.

Continuing to refer to FIG. 2, at block 230, the content recommendation system 110 determines a first resource allocation amount to be allocated to the first recommended content item based on the first resource efficiency value of the first recommended content item and a total resource allocation amount for the recommended content set.

It is assumed that the total resource allocation amount to be allocated is B, the recommended content set is divided into N categories, and the corresponding resource efficiency values of the categories are denoted as type_1, type_2, . . . , type_N. The resource efficiency function of each category is defined as target [type_i]=k[type_i]*∇ecpm[type_i]; where, the target [typeᵢ] represents the target revenue of the ith category of the recommended content items, for example, the value metric; k [typeᵢ] represents the resource efficiency value for the ith category, ∇ecpm[typeᵢ] represents the resource allocation amount for the ith category of the recommended content items.

According to the above Equation (4), the allocation problem of resource allocation of the N categories of recommended content items may be defined as:

$$Arg Max SUM ( target [ type\_i ] ) \qquad ( 6 )$$

$$s . t . SUM ( ∇ ecpm [ type\_i ] ) \leq B$$

According to the above Equation (6), in some embodiments, an optimal solution is to allocate the total resource allocation amount B to a category of recommended content items with the highest resource efficiency value k, that is, type*=Argmax k[type_i].

In some embodiments, considering the stability of different categories of recommended content items in the system, another manner may be applied, that is, the resource for supporting is inclined to the recommended content items with higher resource efficiency values. In other words, for a category of recommended content items with higher resource efficiency values, more resource allocation amount may be allocated from the total resource allocation amount B; whereas, for a category of recommended content items with lower resource efficiencies, less resource allocation amount may be allocated from the total resource allocation amount B. In some embodiments, allocation coefficients allocateCoef[type_i] for respective categories may be determined based on respective resource efficiency values of the plurality of categories, where an allocation coefficient is determined based on a resource efficiency value for the corresponding category and a sum of resource efficiency values for all categories. For example, for the first recommended content item currently considered, the content recommendation system may determine a first allocation coefficient for the first category by comparing the resource efficiency value for the first category with resource efficiency values for other categories in the plurality of categories. For example, for the first category, the allocation coefficient for the first category may be determined based on a ratio of the resource efficiency value for the first category to a sum of resource efficiency values for the plurality of categories. In some embodiments, to avoid the ratio calculated for a certain category being too low, if the ratio is lower than a lower limit for allocation coefficient, the allocation coefficient for the first category may be determined as the lower limit for allocation coefficient. If the ratio is not lower than the lower limit for allocation coefficient, the allocation coefficient for the first category may be determined as the ratio. In some embodiments, the lower limit for allocation coefficient may be configured according to categories.

For example, the allocation coefficient is calculated as follows:

$$allocateCoef [ type\_i ] = max \frac{k [ type\_i ]}{SUM ( k [ type\_i ] )} , MiniCoef [ type\_i ] \qquad ( 7 )$$

In the above Equation (7), MiniCoef[type_i] represents the lower limit for allocation coefficient for the category type_i.

In this way, for each category of recommended content items, the resource allocation amount to be allocated to the recommended content item under the category may be determined from the total resource allocation amount B based at least on the allocation coefficient allocateCoef[type_i] corresponding to the category. For example, the total resource allocation amount to which the category type_i can be allocated can be calculated as:

$$∇ ecpm [ {type}_{i} ] = B * allocateCoef [ type\_i ] \qquad ( 8 )$$

In some embodiments, in the delivery of the delivery opportunity i, if the total resource allocation amount of the category is determined, the allocation coefficient allocateCoef[typeᵢ] may be updated in real time by obtaining the resource efficiency value k[type_i] of each category over a time period. In some embodiments, the spending progress of the total resource allocation amount ∇ecpm[typeᵢ] for each category may also be paced in combination with the dynamic pacing strategy PID to achieve the purpose of smooth consumption. Such allocation solutions may be referred to as dynamic pacing solutions that incorporate resource efficiency. Such an allocation solution may be represented as follows:

$$pacingCoef [ type ] = PID ( ∇ ecpm [ type ] , SUM ( ∇ {ecpm}_{i} [ type ] ) ) \qquad ( 9 )$$

$$∇ {ecpm}_{i} = p acing Co ef [ type ] * pctr\_i * pcvr\_i \qquad ( 10 )$$

According to the above Equation (9), for any category, the pacing coefficient pacingCoef[type] for this category within the current time period may be determined based on the sum of the resource allocation amounts SUM (∇ecpmᵢ[type]) allocated to the recommended content items that have been delivered in each delivery opportunity within the historical time period and the total resource allocation amount ∇ecpm[type] allocated to this category. Then, according to the above Equation (10), for a certain recommended content item and a certain delivery opportunity, the resource allocation amount ∇ecpmᵢ to be allocated to the recommended content item in the delivery of the delivery opportunity may be determined based on the pacing coefficient pacingCoef[type] for the category and an expected click-through rate and an expected conversion rate for the first recommended content item in the delivery opportunity. For each recommended content item in the same category, the resource allocation amount to be allocated in the delivery of each delivery opportunity may be calculated according to the above Equations (9) and (10).

In some embodiments, in order to reduce pacing complexity, the pacing coefficient pacingCoef for the current time period may be calculated for the recommended content set or for the total resource allocation amount B. The pacing coefficient pacingCoef can be based on the total resource allocations and the sum of resource allocations that have been allocated to the recommended content items that have been delivered in the recommended content set within the historical time period, such that the dynamic pacing can be expressed as follows:

$$pacingCoef = PDI ( B , SUM ( ∇ ecpm\_i ) ) \qquad ( 11 )$$

The pacing coefficient pacingCoef calculated according to Equation (11) above may be used to pace spending of the resource allocation amount of all categories of recommended content items to determine the resource allocation amount to be allocated to each recommended content item of each category in the delivery of the current delivery opportunity i. Such pacing coefficient pacingCoef may be referred to as a dynamic global pacing coefficient. In some embodiments, for a recommended content item in a certain category, the dynamic global pacing coefficient pagingCoef and an allocation coefficient for the category allocateCoef[type] are used together to determine the resource allocation amount of each recommended content item in the category, which may be expressed as follows:

$$∇ ecp {m}_{i} = ( pacingCoef * allocateCo ef [ type ] ) * pctr\_i * pcvr\_i \qquad ( 12 )$$

It can be seen that in the above Equation (12), (pacingCoef*allocateCoef[type]) may approximate the theoretical optimal solution pacingCoef[type] in above Equation (9).

For the first recommended content item currently considered, which is divided into the first category, the first resource allocation amount to be allocated to the first recommended content item in the delivery of the delivery opportunity i may be similarly determined according to Equations (11) and (12) above.

Reference is still referred to FIG. 2. At block 240, the content recommendation system 110 determines a first target estimated value metric for the first recommended content item based on the first estimated value metric and the first resource allocation amount. For the delivery of the delivery opportunity i and the first estimated value metric ecpmᵢ, the first target estimated value metric may be represented as ecpm; +∇ecpmᵢ, where ∇ecpmᵢ is a resource allocation amount to be allocated to the first recommended content item in the delivery of the delivery opportunity i, which may be considered an incremental value of the estimated value metric for the first recommended content item.

At block 250, the content recommendation system 110 determines a ranking result of the first recommended content item in the recommended content set based on the first target estimated value metric.

The ranking result will affect whether the first recommended content item will be selected from the recommended content set for delivery. Specifically, the content recommendation system 110 may calculate a target estimated value metric of each recommended content item in the recommended content set. Through the ranking of the target estimated value metric, the recommended content item to be delivered may be selected from the recommended content set according to a preset rule, for example, the recommended content item with the highest ranking may be selected to be delivered in the current delivery opportunity.

FIG. 4 illustrates an example of an architecture 400 for content recommendation in accordance with some embodiments of the present disclosure. It is assumed that for the delivery of the delivery opportunity i, the recommended content set includes K recommended content items, denoted as ad₁, ad₂, . . . , ad_{K}. For these recommended content items, the estimated value metric ecpm₁, ecpm₂, . . . , ecpm_{K} may be calculated respectively. In addition, the content recommendation system 110 further performs content categorization 430 on the K recommended content items, for example, divides the K recommended content items into N categories, and calculates a resource efficiency 440 for each category, expressed as k[type]. Based on the result of the content categorization and the resource efficiency values of respective categories, the allocation coefficient for each category allocateCoef[type] may be determined. In addition, the content recommendation system 110 may further dynamically calculate the pacing coefficient pacingCoef for the current time period through PID control strategy based on the total resource allocation amount B 410 and the sum of the allocated resource allocation amounts 420 within in the historical time period.

Based on the pacing coefficient pacingCoef and the allocation coefficient allocateCoef[type] for each category, and combining the expected click-through rate pctr_i and the expected conversion rate pcvr_i of each recommended content item on the delivery opportunity i, the resource allocation amount ∇ecpmᵢ of each recommended content item may be determined. In this way, the target estimated value metric ecpm₁+∇ecpm₁, ecpm₂+∇ecpm₂, . . . , ecpm_{K}+∇ecpm_{K} of the K recommended content items can be calculated. Based on the ranking result of the target estimated value metric of the K recommended content items, it is assumed that the recommended content item ad₂ with the highest ranking is selected to be delivered in the delivery opportunity i.

The process for content recommendation of FIG. 4 may be iteratively performed and updated. After the delivery of the delivery opportunity i is completed, the sum of allocated resource allocation amounts 420 may also be updated by collect the allocated resource allocation amount ∇ecpm₂ on the recommended content item ad₂ to update the pacing coefficient for the next time period. In addition, the resource allocation amount ∇ecpm₂ and the value metric ecpm₂ of the recommended content item ad₂ are also collected for updating the resource efficiency value of the corresponding category. In some embodiments, updates to the pacing coefficient and the resource efficiency value may be performed in real time one by one, or may be updated periodically. For example, in an embodiment in which updating is performed periodically, length for a time period may be set, resource allocation amounts that have been allocated is collected within the time period for updating the pacing coefficient, and the allocated resource allocation amount and the resulting value metric are collected for updating the resource efficiency value.

According to the embodiment of the present disclosure, in a cold start supporting scene of a given total resource allocation amount, the resource efficiency of the recommended content item is maximized by introducing the resource efficiency, so that the value maximization is achieved. Moreover, in some embodiments, a practical solution for maximizing an optimal solution is also provided, so that calculation complexity of the process for content recommendation is reduced, and implementation is easier.

FIG. 5 illustrates a block diagram of an apparatus 500 for content recommendation according to some embodiments of the present disclosure. The apparatus 500 may be implemented or included in the content recommendation system 110. The various modules/components in the apparatus 500 may be implemented by hardware, software, firmware, or any combination thereof.

As shown, the apparatus 500 includes a value measuring module 510 configured to determine, for a first recommended content item in a recommended content set, a first estimated value metric obtained by delivering the first recommended content item. The apparatus 500 includes an efficiency determining module 520 configured to determine a first resource efficiency value of the first recommended content item based on a historical resource allocation amount and a historical value metric associated with the first recommended content item. The apparatus 500 further includes a resource allocation amount determining module 530 configured to determine a first resource allocation amount to be allocated to the first recommended content item based on the first resource efficiency value of the first recommended content item and a total resource allocation amount for the recommended content set. The apparatus 500 further includes a target value measuring module 540 configured to determine a first target estimated value metric for the first recommended content item based on the first estimated value metric and the first resource allocation amount; and a ranking determining module 550 configured to determine a ranking result of the first recommended content item in the recommended content set based on the first target estimated value metric, the first recommended content item being delivered based on the ranking result.

In some embodiments, the resource allocation amount determining module 530 includes: an allocation coefficient determining module configured to determine a first allocation coefficient for the first recommended content item based on the first resource efficiency value of the first recommended content item; and an allocation coefficient based allocation determining module configured to determine the first resource allocation amount to be allocated to the first recommended content item based at least on the first allocation coefficient and an expected click-through rate and an expected conversion rate for the first recommended content item.

In some embodiments, the resource allocation determining module 530 further includes: a pacing coefficient determining module configured to determine a pacing coefficient for a current time period based on the total resource allocation amount and a sum of resource allocation amounts allocated within a historical time period for recommended content items that have been delivered in the recommended content set; and a pacing coefficient based allocation determining module configured to determine the first resource allocation amount to be allocated to the first recommended content item further based on the pacing coefficient.

In some embodiments, the efficiency determining module 520 includes: a content categorizing module configured to divide recommended content items in the recommended content set into a plurality of categories, the first recommended content item being divided into a first category in the plurality of categories; a category efficiency determining module configured to determine, for each category of the plurality of categories, a resource efficiency value for the category based on historical resource allocation amounts allocated to the category of recommended content items and historical value metrics obtained for presentation of the category of recommended content items; and a content item efficiency determining module configured to determine a resource efficiency value for the first category as the first resource efficiency value of the first recommended content item.

In some embodiments, the historical resource allocation amounts and the historical value metrics satisfy a value function with a linear relationship.

In some embodiments, the resource allocation determining module 530 includes: an allocation coefficient determining module configured to determine a first allocation coefficient for the first category by comparing the resource efficiency value of the first category with resource efficiency values for other categories in the plurality of categories; and an allocation determining module configured to determine, from the total resource allocation amount, the first resource allocation amount to be allocated to the first recommended content item for the delivery based at least on the first allocation coefficient.

In some embodiments, the allocation coefficient-based allocation determining module is configured to determine the first allocation coefficient for the first category based on a ratio of the resource efficiency value of the first category to a sum of resource efficiency values of the plurality of categories.

In some embodiments, the allocation coefficient-based allocation determination module is further configured to: if the ratio is lower than a lower limit for allocation coefficient, determine the allocation coefficient for the first category as the lower limit for allocation coefficient; and if the ratio is not lower than the lower limit for allocation coefficient, determine the allocation coefficient for the first category as the ratio.

FIG. 6 illustrates a block diagram of an electronic device 600 in which one or more embodiments of the present disclosure may be implemented. It shall be understood that the electronic device 600 shown in FIG. 6 is merely exemplary and should not constitute any limitation on the functionality and scope of the embodiments described herein. The electronic device 600 shown in FIG. 6 may be used to implement the content recommendation system 110 or the apparatus 500 of FIG. 5.

As shown in FIG. 6, the electronic device 600 is in the form of a general-purpose computing device. Components of the electronic device 600 may include, but are not limited to, one or more processors or processing units 610, a memory 620, a storage device 630, one or more communications units 640, one or more input devices 650, and one or more output devices 660. The processing unit 610 may be an actual or virtual processor and can perform various processes according to programs stored in the memory 620. In a multiprocessor system, a plurality of processing units execute computer executable instructions in parallel, so as to improve the parallel processing capability of the electronic device 600.

The electronic device 600 typically includes a number of computer storage medium. Such media may be any available media that are accessible by electronic device 600, including, but not limited to, volatile and non-volatile media, removable and non-removable media. The memory 620 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium such as a flash drive, a magnetic disk, or any other medium that can be used to store information and/or data (such as training data for training) and that can be accessed within the electronic device 600.

The electronic device 600 may further include additional removable/non-removable, volatile/nonvolatile storage medium. Although not shown in FIG. 6, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 implements communication with other electronic devices through a communication medium. In addition, functions of components of the electronic device 600 may be implemented by a single computing cluster or a plurality of computing machines, and these computing machines can communicate through a communication connection. Thus, the electronic device 600 may operate in a networked environment using logical connections to one or more other servers, network personal computers (PCs), or another network node.

The input device 650 may be one or more input devices such as a mouse, keyboard, trackball, etc. The output device 660 may be one or more output devices such as a display, speaker, printer, etc. The electronic device 600 may also communicate with one or more external devices (not shown) such as a storage device, a display device, or the like through the communication unit 640 as required, and communicate with one or more devices that enable a user to interact with the electronic device 600, or communicate with any device (e. g., a network card, a modem, or the like) that enables the electronic device 600 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand various implementations disclosed herein.

I/We claim:

1. A method for content recommendation, comprising:
determining, for a first recommended content item in a recommended content set, a first estimated value metric obtained by delivering the first recommended content item;
determining a first resource efficiency value of the first recommended content item based on a historical resource allocation amount and a historical value metric associated with the first recommended content item;
determining a first resource allocation amount to be allocated to the first recommended content item based on the first resource efficiency value of the first recommended content item and a total resource allocation amount for the recommended content set;
determining a first target estimated value metric for the first recommended content item based on the first estimated value metric and the first resource allocation amount; and
determining a ranking result of the first recommended content item in the recommended content set based on the first target estimated value metric, the first recommended content item being delivered based on the ranking result.

2. The method of claim 1, wherein determining the first resource allocation amount to be allocated to the first recommended content item comprises:
determining a first allocation coefficient for the first recommended content item based on the first resource efficiency value of the first recommended content item; and
determining the first resource allocation amount to be allocated to the first recommended content item based at least on the first allocation coefficient, and an expected click-through rate and an expected conversion rate for the first recommended content item.

3. The method of claim 2, wherein determining the first resource allocation amount to be allocated to the first recommended content item further comprises:
determining a pacing coefficient for a current time period based on the total resource allocation amount and a sum of resource allocation amounts allocated within a historical time period for recommended content items that have been delivered in the recommended content set; and
determining the first resource allocation amount to be allocated to the first recommended content item further based on the pacing coefficient.

4. The method of claim 1, wherein determining the first resource efficiency value of the first recommended content item comprises:
dividing recommended content items in the recommended content set into a plurality of categories, the first recommended content item being divided into a first category in the plurality of categories;
for each category of the plurality of categories, determining a resource efficiency value for the category based on historical resource allocation amounts allocated to the category of recommended content items and historical value metrics obtained for presentation of the category of recommended content items; and
determining a resource efficiency value for the first category as the first resource efficiency value of the first recommended content item.

5. The method of claim 4, wherein the historical resource allocation amounts and the historical value metrics satisfy a value function with a linear relationship.

6. The method of claim 4, wherein determining the first resource allocation amount to be allocated to the first recommended content item comprises:
determining a first allocation coefficient for the first category by comparing the resource efficiency value of the first category with resource efficiency values of other categories in the plurality of categories; and
determining, from the total resource allocation amount, the first resource allocation amount to be allocated to the first recommended content item in the delivery based at least on the first allocation coefficient.

7. The method of claim 6, wherein determining the first allocation coefficient for the first category comprises:
determining the first allocation coefficient for the first category based on a ratio of the resource efficiency value of the first category to a sum of resource efficiency values of the plurality of categories.

8. The method of claim 7, wherein determining the first allocation coefficient for the first category based on the ratio comprises:
in response to the ratio being lower than a lower limit for allocation coefficient, determining the allocation coefficient for the first category as the lower limit for allocation coefficient; and
in response to the ratio being not lower than the lower limit for allocation coefficient, determining the allocation coefficient for the first category as the ratio.

9. An electronic device comprising:
at least one processing unit; and
at least one memory, the at least one memory being coupled to the at least one processing unit and storing instructions for execution by the at least one processing unit, the instructions, when executed by the at least one processing unit, causing the device to perform acts comprising:
determining, for a first recommended content item in a recommended content set, a first estimated value metric obtained by delivering the first recommended content item;
determining a first resource efficiency value of the first recommended content item based on a historical resource allocation amount and a historical value metric associated with the first recommended content item;
determining a first resource allocation amount to be allocated to the first recommended content item based on the first resource efficiency value of the first recommended content item and a total resource allocation amount for the recommended content set;
determining a first target estimated value metric for the first recommended content item based on the first estimated value metric and the first resource allocation amount; and
determining a ranking result of the first recommended content item in the recommended content set based on the first target estimated value metric, the first recommended content item being delivered based on the ranking result.

10. The device of claim 9, wherein determining the first resource allocation amount to be allocated to the first recommended content item comprises:
determining a first allocation coefficient for the first recommended content item based on the first resource efficiency value of the first recommended content item; and
determining the first resource allocation amount to be allocated to the first recommended content item based at least on the first allocation coefficient and an expected click-through rate and an expected conversion rate for the first recommended content item.

11. The device of claim 10, wherein determining the first resource allocation amount to be allocated to the first recommended content item further comprises:
determining a pacing coefficient for a current time period based on the total resource allocation amount and a sum of resource allocation amounts allocated within a historical time period for recommended content items that have been delivered in the recommended content set; and
determining the first resource allocation amount to be allocated to the first recommended content item further based on the pacing coefficient.

12. The device of claim 9, wherein determining the first resource efficiency value of the first recommended content item comprises:
dividing recommended content items in the recommended content set into a plurality of categories, the first recommended content item being divided into a first category in the plurality of categories;
for each category of the plurality of categories, determining a resource efficiency value for the category based on historical resource allocation amounts allocated to the category of recommended content items and historical value metrics obtained for presentation of the category of recommended content items; and
determining a resource efficiency value for the first category as the first resource efficiency value of the first recommended content item.

13. The device of claim 12, wherein the historical resource allocation amounts and the historical value metrics satisfy a value function with a linear relationship.

14. The device of claim 12, wherein determining the first resource allocation amount to be allocated to the first recommended content item comprises:
determining a first allocation coefficient for the first category by comparing the resource efficiency value of the first category with resource efficiency values of other categories in the plurality of categories; and
determining, from the total resource allocation amount, the first resource allocation amount to be allocated to the first recommended content item in the delivery based at least on the first allocation coefficient.

15. The device of claim 14, wherein determining the first allocation coefficient for the first category comprises:
determining the first allocation coefficient for the first category based on a ratio of the resource efficiency value of the first category to a sum of resource efficiency values of the plurality of categories.

16. The device of claim 15, wherein determining the first allocation coefficient for the first category based on the ratio comprises:
in response to the ratio being lower than a lower limit for allocation coefficient, determining the allocation coefficient for the first category as the lower limit for allocation coefficient; and
in response to the ratio being not lower than the lower limit for allocation coefficient, determining the allocation coefficient for the first category as the ratio.

17. A non-transitory computer readable storage medium having a computer program stored thereon which, when executed by a processor, causes a device to perform acts comprising:
determining, for a first recommended content item in a recommended content set, a first estimated value metric obtained by delivering the first recommended content item;
determining a first resource efficiency value of the first recommended content item based on a historical resource allocation amount and a historical value metric associated with the first recommended content item;
determining a first resource allocation amount to be allocated to the first recommended content item based on the first resource efficiency value of the first recommended content item and a total resource allocation amount for the recommended content set;
determining a first target estimated value metric for the first recommended content item based on the first estimated value metric and the first resource allocation amount; and
determining a ranking result of the first recommended content item in the recommended content set based on the first target estimated value metric, the first recommended content item being delivered based on the ranking result.

18. The non-transitory computer readable storage medium of claim 17, wherein determining the first resource allocation amount to be allocated to the first recommended content item comprises:
determining a first allocation coefficient for the first recommended content item based on the first resource efficiency value of the first recommended content item; and
determining the first resource allocation amount to be allocated to the first recommended content item based at least on the first allocation coefficient and an expected click-through rate and an expected conversion rate for the first recommended content item.

19. The non-transitory computer readable storage medium of claim 18, wherein determining the first resource allocation amount to be allocated to the first recommended content item further comprises:
determining a pacing coefficient for a current time period based on the total resource allocation amount and a sum of resource allocation amounts allocated within a historical time period for recommended content items that have been delivered in the recommended content set; and
determining the first resource allocation amount to be allocated to the first recommended content item further based on the pacing coefficient.

20. The non-transitory computer readable storage medium of claim 17, wherein determining the first resource efficiency value of the first recommended content item comprises:
dividing recommended content items in the recommended content set into a plurality of categories, the first recommended content item being divided into a first category in the plurality of categories;
for each category of the plurality of categories, determining a resource efficiency value for the category based on historical resource allocation amounts allocated to the category of recommended content items and historical value metrics obtained for presentation of the category of recommended content items; and
determining a resource efficiency value for the first category as the first resource efficiency value of the first recommended content item.
